(19) United States
(12) Patent Application Publication
(10) Pub. No.: US 2007/0059088 A1
(43) Pub. Date: Mar. 15, 2007

(54) Lipstick mechanism

(75) Inventor: Li-Chun Chan, Taichung City (TW)

Correspondence Address: LEONG C LEI, PMB # 1008, 1867 YGNACIO VALLEY ROAD, WALNUT CREEK, CA, 94598, US

(73) Assignee: SHYA HSIN PLASTIC WORKS CO., LTD.

(21) Appl. No.: 11/225,073

(22) Filed: Sep. 14, 2005

(51) Int. Cl. B43K 21/08; A45D 40/04

(52) U.S. Cl. 401/75; 401/68

(57) ABSTRACT

A lipstick mechanism which includes an inner tubular member having a bottom provided with a rotatable base and two opposite sides provided with two Z-shaped slots, a tubular seat used for receiving a lipstick and having two opposite sides provided with two protuberances, an outer tubular member having an inner surface formed with two spiral grooves, the outer tubular member being fitted over the inner tubular member, with a lower end of the outer tubular member in contact with the resilient lugs and the spiral grooves receiving the protuberances thereby providing a space between the inner tubular member and the outer tubular member; whereby the space between the inner and outer tubular members provided by the resilient lugs will prevent the an outer surface of the inner tubular member from contacting an inner surface of the outer tubular member thus ensuring smooth rotation of the inner tubular member.

### BACKGROUND OF THE INVENTION

1. Field of the invention

This invention is related to an improvement in the structure of a lipstick mechanism, and in particular it can be rotated steadily and smoothly without lubricant.

2. Description of the Prior Art

The conventional lipstick containers generally include a cosmetic carrier, an inner tubular sleeve, an outer tubular sleeve and a decorative sleeve. Most common cosmetic carriers support the lipstick and are configured as a sleeve with radially extending lugs on the opposing sides that is received within the inner sleeve. The inner tubular sleeve defines longitudinally extending slots on the opposing sides in which the lugs of the cosmetic carrier would extend through. The outer tubular sleeve defining a continuous helical channel is positioned about/on the inner tubular sleeve whereas the lugs of the cosmetic carrier are configured to be received within and to traverse along the length of the helical channel, thus resulting in the cosmetic carrier's ability to move upward as the lugs traverse the length of the helical channel when a bottom portion of the inner tubular sleeve is rotated. The decorative outermost sleeve is provided for aesthetic purposes. In operation, a bottom portion of the inner tubular sleeve extends beyond the bottom of the outer decorative sleeve. The user rotates the bottom portion, which causes the cosmetic carrier or the lipstick to extend from the case for applying the lipstick and also to retract into the case for storage. However, as the inner and outer tubular sleeves are made of plastic material, they are not exactly cylindrical in shape thereby often causing interference in rotation. Furthermore, installation of the tubular seat for receiving a lipstick into the inner tubular sleeve will often cause the deformation of the assembly thus making it difficult to control the lipstick to go in or out of the assembly. Hence, it is proposed to coat a layer of lubricant between the inner and outer tubular sleeves, but in case the lubricant gets in touch with the lipstick, the lipstick will be contaminated, seriously influencing the health of the user. Moreover, when the lipstick is being used with too much force, the lipstick will tend to retract into the container thus causing much inconvenience in use.

### SUMMARY OF THE INVENTION

According to the present invention, there is provided a lipstick mechanism comprising an inner tubular member having a bottom provided with a rotatable base and two opposite sides provided with two Z-shaped slots, said inner tubular member being rotatable in unison with said rotatable base, said inner tubular member having a lower portion provided with a plurality of equidistant resilient lugs, a tubular seat used for receiving a lipstick and having two opposite sides provided with two protuberances, said tubular seat being fitted into said inner tubular member, with said protuberances slidably engaged with said Z-shaped slots thereby enabling said tubular seat to be moved up and down in said inner tubular member, an outer tubular member having an inner surface formed with two spiral grooves, said outer tubular member being fitted over said inner tubular member, with a lower end of said outer tubular member in contact with said resilient lugs and said spiral grooves receiving said protuberances thereby providing a space between said inner tubular member and said outer tubular member, whereby said space between said inner and outer tubular members provided by said resilient lugs will prevent said an outer surface of said inner tubular member from contacting an inner surface of said outer tubular member thus ensuring smooth rotation of said inner tubular member with respect to said outer tubular member.

The foregoing summary provides only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THESE DRAWINGS

FIG. 1 is an exploded view of the lipstick mechanism according to the present invention;

FIG. 2A is a sectional view of the lipstick mechanism according to the present invention;

FIG. 2B is an enlarged view of a portion of FIG. 2A;

FIG. 3 is a perspective view of the lipstick mechanism according to the present invention;

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

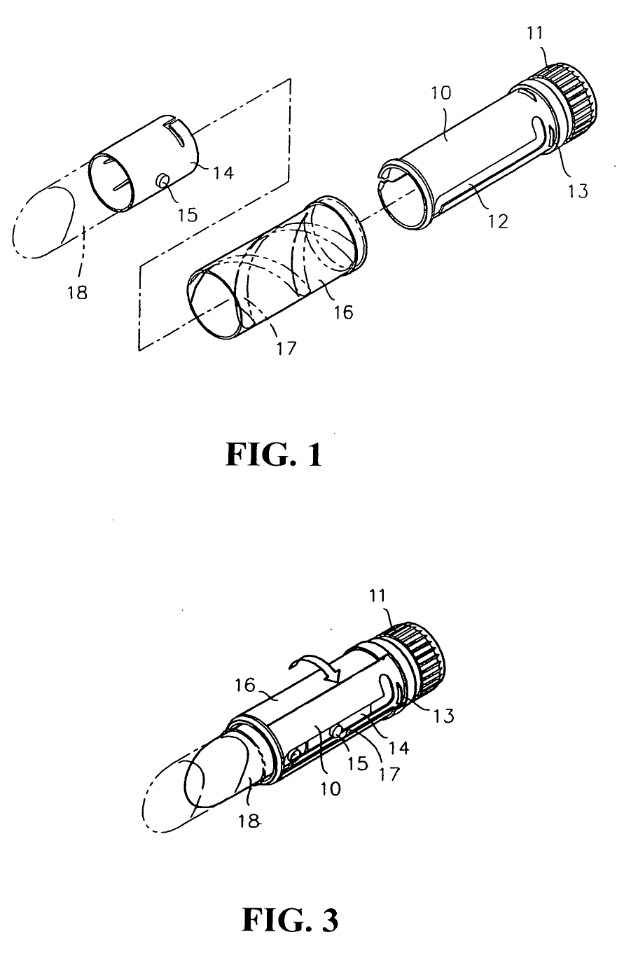

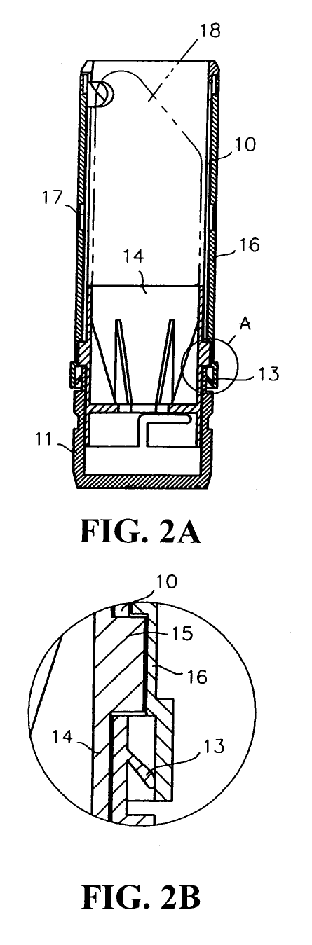

Referring to FIGS. 1 and 3, the lipstick mechanism according to the present invention comprises an inner tubular member 10, an outer tubular member 16 and a tubular seat 14. The inner tubular member 10 is provided with a rotatable base 11 at the bottom and two Z-shaped slots at two opposite sides. The rotatable base 11 is fixedly connected or integrally formed with the bottom of the inner tubular member 10 so that the inner tubular member 10 will be rotated with the rotatable base 11. The inner tubular member 10 has a plurality of equidistant resilient lugs 13 extending downwardly and outwardly from the lower portion closed to the rotatable base 11. The tubular seat 14 is used for receiving a lipstick 18 and is provided with two protuberances 15 at two opposite sides thereof. The tubular seat 14 is fitted into the inner tubular member 10, with the protuberances 15 of the former slidably engaged with the Z-shaped slots 12 of the latter, so that the tubular seat 14 may be moved up and down in the inner tubular member 10. The outer tubular member 16 is formed with two spiral grooves 17 at the inner surface thereof The outer tubular member 16 is fitted over the inner tubular member 10, with the lower end of the outer tubular member 16 in contact with the resilient lugs 13 of the inner tubular member 10 and the spiral grooves 17 of the outer tubular member 16 receiving the protuberances 15 of the tubular seat 14, so that a space will be provided between the inner tubular member 10 and the outer tubular member 16 and when the rotatable base 11 is rotated relative to the outer tubular member 16, the protuberances 15 will be guided along the Z-shaped slots 12 and the spiral grooves 17 and the tubular seat 14 will be moved in or out of the outer tubular member 16 thereby controlling the lipstick 18 to go in or out of the outer tubular member 16. As the resilient lugs 13 provide a space between the inner tubular member 10 and the outer tubular member 16, the outer surface of the inner tubular member 10 will be prevented from contacting the inner surface of the outer tubular member 16 thus ensuring the smooth rotation of the inner tubular member 10 with respect to the outer tubular member 16. Furthermore, since the resilient lugs 13 will apply an appropriate force on the outer tubular member 16, the lipstick 18 will not retract into the outer tubular member 16 even if a pressure is applied to the lipstick 18 in use.

The present invention is characterized by the resilient lugs 13 provided equidistantly on the outer side of the lower portion of the inner tubular member 10 to provide a space between the inner tubular member 10 and the outer tubular member 16 thereby ensuring smooth and steady rotation of the inner tubular member 10 relative to the outer tubular member 16 without applying lubricant between the inner tubular member 10 and the outer tubular member 16. The conventional way to ensure smooth rotation of the inner tubular member in relation to the outer tubular member is to apply lubricant therebetween, which will contaminate the lipstick when in contact therewith.

With the invention thus explained, it is apparent that various modifications and variations can be made without departing from the spirit of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-2. (canceled)

3. A lipstick case comprising:
an inner tubular member having a bottom provided with a rotatable base and two opposite sides provided with two Z-shaped slots, said inner tubular member being rotatable in unison with said rotatable base, said inner tubular member having a lower portion provided with a plurality of equidistant resilient lugs, said resilient lugs extending outwardly in a horizontal direction;
a tubular seat used for receiving a lipstick and having two opposite sides provided with two protuberances, said tubular seat being fitted into said inner tubular member, with said protuberances slidably engaged with said Z-shaped slots thereby enabling said tubular seat to be moved up and down in said inner tubular member; and
an outer tubular member having an inner surface formed with two spiral grooves, said outer tubular member being fitted over said inner tubular member, with a lower end of said outer tubular member in contact with said resilient lugs and said spiral grooves receiving said protuberances thereby providing a space between said inner tubular member and said outer tubular member;
whereby said space between said inner and outer tubular members provided by said resilient lugs prevent an outer surface of said inner tubular member from contacting an inner surface of said outer tubular member thus ensuring smooth rotation of said inner tubular member with respect to said outer tubular member, and when said outer tubular member is put on said inner tubular member, said resilient lugs are forced to bend downwardly thereby providing a resilient force to said outer tubular member.
